(19) United States
(12) Patent Application Publication
(10) Pub. No.: US 2013/0094630 A1
(43) Pub. Date: Apr. 18, 2013

(54) MOBILE C-ARM X-RAY DEVICE HAVING AN ANTI-TILT DEVICE

(71) Applicants: ANDREAS LIMMER, Furth (DE); RUDOLF SIEBENHAAR, Poxdorf (DE)

(72) Inventors: ANDREAS LIMMER, Furth (DE); RUDOLF SIEBENHAAR, Poxdorf (DE)

(21) Appl. No.: 13/434,626

(22) Filed: Mar. 29, 2012

(30) Foreign Application Priority Data
Mar. 31, 2011 (DE) 10 2011 006 505.9

(51) Int. Cl. H05G 1/02

(52) U.S. Cl. CPC H05G 1/02
USPC 378/198

(57) ABSTRACT

A mobile C-arm x-ray device includes a C-arm and a C-arm supporting apparatus that is movable on wheels. The C-arm is rotatably arranged on the C-arm supporting apparatus about a vertical axis of rotation. An anti-tilt device that rotates about the vertical axis of rotation at the same time and in the same direction as the C-arm during a rotation movement of the C-arm reduces the tilting hazard of the mobile C-arm x-ray device.

This application claims the benefit of DE 10 2011 006 505.9, filed on Mar. 31, 2011.

### BACKGROUND

The present embodiments relate to a mobile C-arm x-ray device.

Mobile x-ray devices with C-arms may include a supporting apparatus that is mounted on wheels or rollers. A C-arm with an x-ray source and an x-ray detector is fastened on the supporting apparatus for the purpose of diagnostic imaging. FIG. 1 shows a perspective view of a mobile C-arm x-ray device of this type (e.g., as is disclosed in DE 10 2008 026 622 A1).

FIG. 1 shows an x-ray C-arm 1 arranged on a supporting apparatus 2 with rollers 6. The x-ray C-arm 1 and the supporting apparatus 2 are connected to one another by way of a C-arm retaining module 5. An x-ray emitter 3 and/or an x-ray detector 4 are disposed on ends of the x-ray C-arm 1. A patient on a couch may be irradiated with x-rays with the aid of the x-ray emitter 3, for example. X-rays are received by the x-ray detector 4. The x-ray C-arm 1 connected to the C-arm retaining module 5 may be moved horizontally.

To achieve more freedom of movement for examinations, the x-ray C-arm may be rotatably mounted about one or more vertical axes of rotation. As a result, the examination range may be enlarged without having to move a patient. DE 10 111 798 A1 shows an arrangement of this type. The rotation about the axis of rotation is braked in this way in order to prevent an unintentional twisting of the C-arm. During rotation, the C-arm and a horizontal unit are rotated. The center of gravity of the C-arm is also moved, which results in a tilting hazard in the case of larger deflections. Anti-tilt measures are therefore taken to improve stability. For example, a large wheelbase reduces the tilting hazard.

U.S. Pat. No. 6,131,690 A discloses a mobile C-arm x-ray device having a supporting wheel that may be moved in the direction of the C-arm.

DE 10 2006 011 234 A1 and DE 10 2006 011 236 A1 disclose mobile x-ray recording apparatuses on moveable rollers.

### SUMMARY AND DESCRIPTION

The present embodiments may obviate one or more of the drawbacks or limitations in the related art. For example, the tilting hazard for mobile C-arm x-ray devices is reduced.

In one embodiment, a mobile C-arm x-ray device includes a C-arm and a C-arm supporting apparatus that may be moved with wheels. The C-arm is rotatably arranged on the C-arm supporting apparatus about a vertical axis of rotation. An anti-tilt device that rotates about the vertical axis of rotation at the same time and in the same direction as the C-arm during a rotational movement of the C-arm, reduces the tilting hazard of the C-arm x-ray device. The present embodiments are advantageous in that the wheelbase does not have to be enlarged despite a large area of rotation of the C-arm, and no heavy static masses are needed.

In one embodiment, an angle of rotation of the rotational movement of the C-arm and a rotational movement of the anti-tilt device are identical.

In another embodiment, the anti-tilt device includes a compensating mass arranged opposite to the C-arm and at a distance from the vertical axis of rotation. This is advantageous in that a moved mass may be lighter than a static mass.

The compensating mass may be arranged on a pivot arm.

In a further embodiment, the compensating mass may be arranged on a lower side of the supporting apparatus at a height of the wheels.

### BRIEF DESCRIPTION OF THE DRAWINGS

FIG. 1 shows a mobile C-arm x-ray device according to the prior art;

FIG. 2 shows a top view of one embodiment of a mobile C-arm x-ray device with a moveable compensating mass;

FIG. 3 shows a side view of one embodiment of a mobile C-arm x-ray device with a moveable compensating mass;

FIG. 4 shows a top view of one embodiment of a mobile C-arm x-ray device with a supporting wheel/pedestal; and

FIG. 5 shows a side view of a mobile C-arm x-ray device with a supporting wheel.

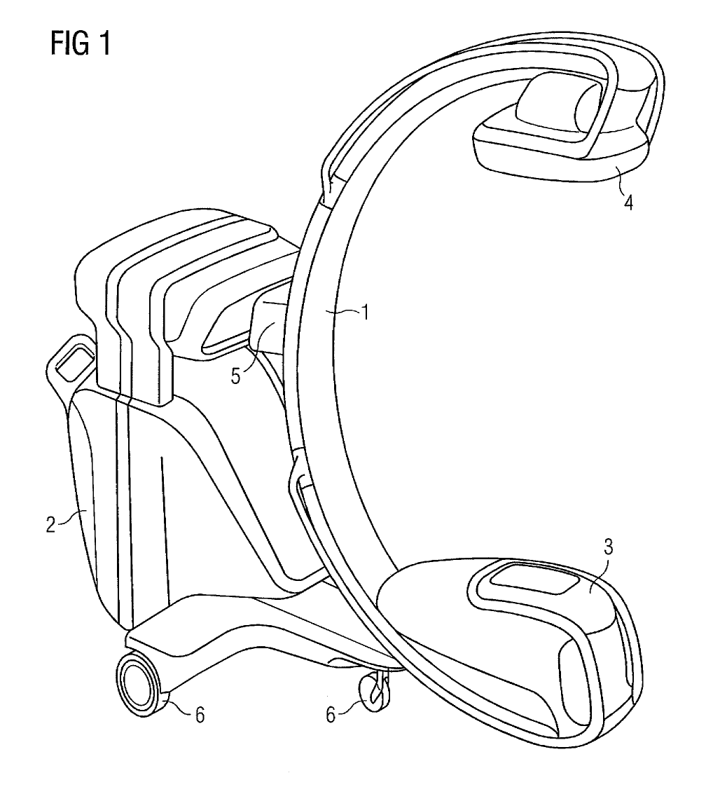

### DETAILED DESCRIPTION OF THE DRAWINGS

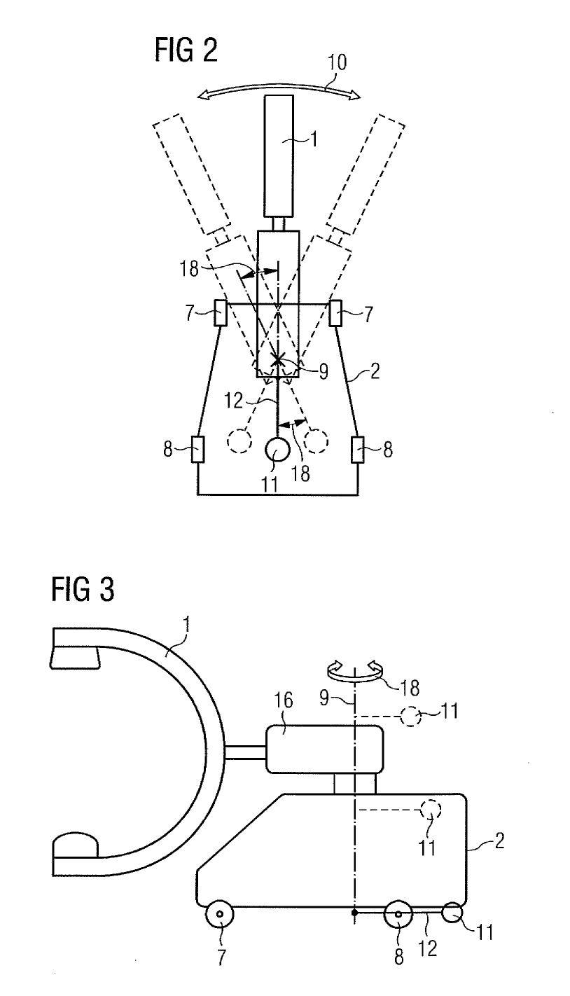

FIG. 2 shows a top view of one embodiment of a mobile C-arm x-ray device with a supporting apparatus 2 that may be moved with two front wheels 7 and two rear wheels 8. A C-arm 1 is pivotably connected to the supporting apparatus 2 about a vertical axis of rotation 9. Three different pivoting positions are shown in FIG. 2 (e.g., a central position and two deflected positions). To provide that the C-arm x-ray device does not tilt, an overall center of gravity comes to rest within a footprint spanned by the front and rear wheels 7, 8. The closer the center of gravity to the wheels of the footprint, the greater the tilting hazard and/or tendency to tilt. Even minimal external forces may then cause the device to tilt.

To provide that the center of gravity remains within the footprint during a rotational movement, a compensating mass 11 is rotatably arranged about the vertical axis of rotation 9 and is coupled to the rotational movement 10 of the C-arm 1 by a pivot arm 12. As a result, the two angles of rotation 18 are equally sized. The compensating mass 11 lies opposite to the C-arm so that the weight of the compensating mass 11 displaces the center of gravity toward the vertical axis of rotation 9. A center of gravity displacement that enhances the tilt by rotating the C-arm 1 about the vertical axis of rotation 9 is therefore counteracted by the compensating mass 11. The stability of the mobile C-arm x-ray device is increased and the tendency to tilt and tilting hazard are reduced.

FIG. 3 shows a side view of one embodiment of the C-arm x-ray device from FIG. 2. The supporting apparatus 2 with the C-arm 1 that is pivotably mounted about the vertical axis of rotation 9 is shown. The supporting apparatus 2 includes two front wheels 7 and two rear wheels 8. The compensating mass 11 is rotatably mounted about the vertical axis of rotation 9 by the pivot arm 12. The compensating mass 11 may be arranged in different vertical positions. A position at the height of the front and rear wheels 7, 9 on a lower side of the supporting apparatus 2, a further position on an upper side of the supporting apparatus 2, and a further position above a C-arm retaining module 16 are visible. With a compensating mass 11 with the same effect, the length of the pivot arm 12 may be shorter, the greater the vertical distance from the front and rear wheels 7, 8.

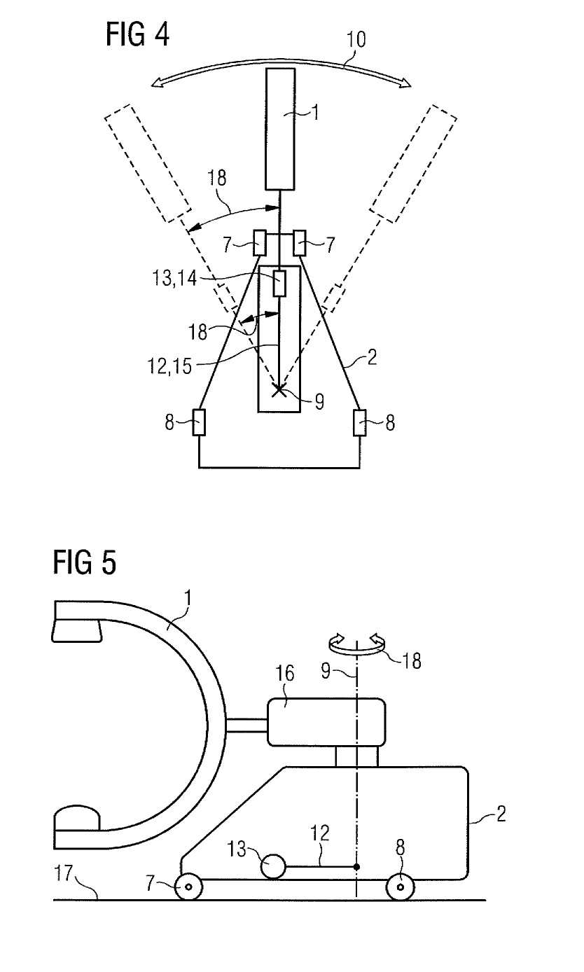

FIG. 4 shows another embodiment of a mobile C-arm x-ray device having an anti-tilt device. The top view shows a mobile C-arm x-ray device having a supporting apparatus 2 that may be moved with two front wheels 7 and two rear wheels 8. A C-arm 1 is pivotably connected to the supporting apparatus 2 about a vertical axis of rotation 9. FIG. 4 shows three different swiveled positions (e.g., a central position and two deflected positions). To provide that the C-arm x-ray device does not tilt, a center of gravity of the C-arm x-ray device is to come to rest within the footprint spanned by the front and rear wheels 7, 8. The closer the center of gravity to the wheels of the footprint, the greater the tendency to tilt. Even minimal external additional forces may then cause the device to tilt.

In order to prevent the tilting and to span a larger footprint of the C-arm x-ray device, a supporting wheel 13 that is rotatably mounted on the lower side of the supporting apparatus 2, on a pivot arm 12 about the vertical axis of rotation 9 is used. The supporting wheel 13 points in the direction of the C-arm 1 and may be automatically rotated therewith. The rotational movement is designated with 10. Alternatively, a manual adjustment independent of the movement of the C-arm 1 is possible. The pivot arm 12 may also be embodied to be extendable as a telescope-type pivot arm 15, and a pedestal 14 may be used instead of the supporting wheel 13. The longer the retaining arm 15, the greater the support against tilting. A possible tendency of the C-arm x-ray device to tilt is averted by the supporting wheel 13 and/or the pedestal 14, and the tilting is prevented.

FIG. 5 shows a side view of the C-arm x-ray device from FIG. 4. The supporting apparatus 2 with the C-arm 1, which is pivotably mounted about the vertical axis of rotation 9, is shown. The supporting apparatus 2 includes two front wheels 7 and two rear wheels 8. The supporting wheel 13 is rotatably mounted about the vertical axis of rotation 9 by the pivot arm 12. The supporting wheel 13 is slightly remote from the floor 17, on which the C-arm x-ray device may be moved, so that with the rotational movement 10 or when traveling, the supporting wheel does not graze the floor 17 and/or is not obstructed by ground sills or bumps.

In a further embodiment, several pedestals may also be used. The pedestals are, for example, extended to the left and the right from the supporting apparatus 2 (e.g., similar to the lateral supports of cranes or mobile diggers).

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A mobile C-arm x-ray device comprising:
a C-arm;
a C-arm supporting apparatus that is movable on wheels, the C-arm being rotatably arranged about a vertical axis of rotation relative to the C-arm supporting apparatus; and
an anti-tilt device that rotates about the vertical axis of rotation at a same time and in a same direction as the C-arm during a rotational movement of the C-arm, the anti-tilt device being operable to reduce the tendency of the C-arm x-ray device to tilt.

2. The mobile C-arm x-ray device as claimed in claim 1, wherein a rotational angle of the rotational movement of the C-arm and a rotation movement of the anti-tilt device are identical.

3. The mobile C-arm x-ray device as claimed in claim 1, wherein the anti-tilt device includes a compensating mass that is remote from the vertical axis of rotation, and
wherein the compensating mass is arranged opposite the C-arm with respect to the vertical axis of rotation.

4. The mobile C-arm x-ray device as claimed in claim 3, wherein the compensating mass is arranged on a pivot arm.

5. The mobile C-arm x-ray device as claimed in claim 3, wherein the compensating mass is arranged on a lower side of the C-arm supporting apparatus at a height of the wheels.

6. The mobile C-arm x-ray device as claimed in claim 2, wherein the anti-tilt device includes a compensating mass that is remote from the vertical axis of rotation, and
wherein the compensating mass is arranged opposite the C-arm with respect to the vertical axis of rotation.

7. The mobile C-arm x-ray device as claimed in claim 4, wherein the compensating mass is arranged on a lower side of the C-arm supporting apparatus at a height of the wheels.
